(19) United States
(12) Patent Application Publication
(10) Pub. No.: US 2024/0152304 A1
(43) Pub. Date: May 9, 2024

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventors: Ami KANZAKI, Kanagawa (JP); Naoto YAMASAKI, Kanagawa (JP)

(73) Assignee: FUJIFILM Business Innovation Corp., Tokyo (JP)

(21) Appl. No.: 18/313,348

(22) Filed: May 7, 2023

(30) Foreign Application Priority Data
Nov. 7, 2022 (JP) 2022-178293

(51) Int. Cl. G06F 3/12

(52) U.S. Cl. CPC G06F 3/1275; G06F 3/1204; G06F 3/1253

(57) ABSTRACT

An information processing apparatus includes a processor configured to receive information on plural parts that configure a product, display process candidates for manufacturing the parts on a display unit, receive selection of a process from among the process candidates, for each of the parts, and create a workflow related to manufacturing of the product, including the selected process.

### CROSS-REFERENCE TO RELATED APPLICATIONS

This application is based on and claims priority under 35 USC 119 from Japanese Patent Application No. 2022-178293 filed Nov. 7, 2022.

### BACKGROUND

### (i) Technical Field

The present invention relates to an information processing apparatus and a non-transitory computer readable medium storing a program.

### (ii) Related Art

JP2022-25632A discloses an information processing apparatus including a processor configured to: specify a plurality of parts for manufacturing an ordered product; specify a plurality of processes required from receiving an order for the product to completing the product using the plurality of parts; generate an intermediate object representing an intermediate part, for the intermediate part created by processing at least two parts of the plurality of parts; generate a work object representing a process required to manufacture each individual part, for each of the plurality of parts; and create workflow information in which for each of the plurality of parts, the work objects representing the processes required for manufacturing each part are displayed arranged in order of the plurality of processes, and the work objects between processes to be continuously processed are associated and displayed, and an intermediate object representing the intermediate part is associated with work objects for the at least two parts used to generate the intermediate part.

JP2017-49848A discloses an information processing apparatus including: first generation means for generating a display screen with units of products generated through a plurality of processes as display columns; second generation means for generating a display screen with units of processes as display columns; display control means for displaying any one of a display screen generated by the first generation means and a display screen generated by the second generation means; and switching means for switching the display screen generated by the first generation means to the display screen generated by the second generation means, or switching the display screen generated by the second generation means to the display screen generated by the first generation means.

### SUMMARY

In order to manage the manufacture of a product, it is necessary to create a workflow representing a manufacturing process of the product, in addition to information on parts configuring the product to be manufactured.

Aspects of non-limiting embodiments of the present disclosure relate to an information processing apparatus and a non-transitory computer readable medium storing a program capable of reducing the effort of creating information to manage product manufacturing, compared to the case of creating information on a product including a plurality of parts, and information to manage product manufacturing by creating a workflow template that applies to the information on the product and applying the created template to the information on the product.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive information on a plurality of parts that configure a product; display process candidates for manufacturing the parts on a display unit; receive selection of a process from among the process candidates, for each of the parts; and create a workflow related to manufacturing of the product, including the selected process.

### BRIEF DESCRIPTION OF THE DRAWINGS

Exemplary embodiment(s) of the present invention will be described in detail based on the following figures, wherein:

FIG. 1 is a diagram illustrating a schematic configuration of a printing processing system according to an exemplary embodiment;

FIG. 2 is a block diagram showing an example of an electrical configuration of an information processing apparatus according to the exemplary embodiment;

FIG. 3 is an explanatory diagram for explaining types and orders of processes according to the exemplary embodiment;

FIG. 4 is a diagram showing a display example for creating a workflow on a display unit according to the exemplary embodiment;

FIG. 5 is a diagram showing a display example for creating a workflow on the display unit according to the exemplary embodiment;

FIG. 6 is a diagram showing a display example in which candidates for processes according to the exemplary embodiment are displayed on the display unit;

FIG. 7 is a diagram showing a display example for creating a workflow on the display unit according to the exemplary embodiment;

FIG. 8 is a diagram showing a display example for creating a workflow on the display unit according to the exemplary embodiment;

FIG. 9 is a diagram showing a display example for creating a workflow on the display unit according to the exemplary embodiment;

FIG. 10 is a flowchart showing an example of a flow of a part creation process of an information processing program according to the exemplary embodiment;

FIG. 11 is a flowchart showing an example of a flow of a process addition process of the information processing program according to the exemplary embodiment; and

FIG. 12 is a diagram showing a display example for creating a workflow on the display unit according to the exemplary embodiment.

### DETAILED DESCRIPTION

### Exemplary Embodiment

Hereinafter, an example of the exemplary embodiment of the present disclosure will be described with reference to the drawings. The identical reference numerals are given to the identical or equivalent components and parts in each drawing. In addition, the dimensional ratios in the drawings are exaggerated for convenience of explanation and may differ from the actual ratios.

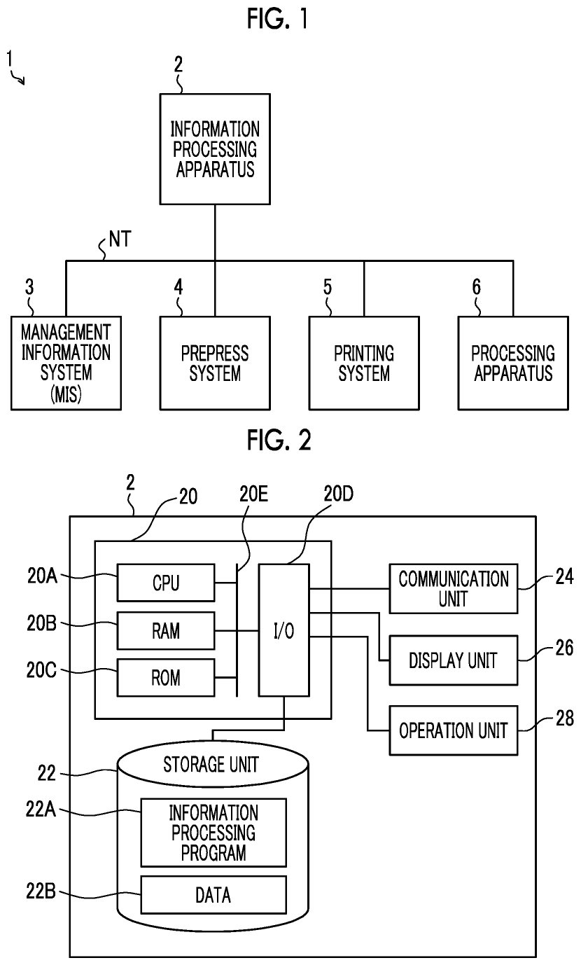

An example of a printing processing system 1 according to the present exemplary embodiment will be described with reference to FIG. 1.

FIG. 1 is a diagram illustrating a schematic configuration of the printing processing system 1 according to the exemplary embodiment for implementing the technique of the present disclosure.

As shown in FIG. 1, the printing processing system 1 includes an information processing apparatus 2, a management information system 3, a prepress system 4, a printing system 5, and a processing apparatus 6. The information processing apparatus 2, the management information system 3, the prepress system 4, the printing system 5, and the processing apparatus 6 are connected to a network NT and are configured to be able to exchange information with each other. The network NT is, for example, the Internet, a local area network (LAN), a wide area network (WAN), or the like.

The information processing apparatus 2 is a computer system having a workflow creation support function of supporting creation of a workflow for performing printing business. As an example, a general-purpose computer device such as a server computer or a personal computer (PC) is applied to the information processing apparatus 2.

The management information system (hereinafter, it is referred to as MIS) 3 is a computer system that manages management information related to printing, and performs production process management and inventory management of printed products. The management information may include, for example, various types of information such as order information, estimation information, sales information, management plan, and inventory information. In the present exemplary embodiment, a case where the MIS 3 transmits information necessary for manufacturing a printed product in an extensible markup language (XML) format will be described as an example. The MIS 3 may use information such as job definition format (JDF) and job messaging format (JMF).

The prepress system 4 is a computer system that performs a “prepress” process. As an example, a system including a digital printing apparatus that performs printing without using a printing plate and an offset printing apparatus that performs printing using a printing plate is applied to the prepress system 4.

The printing system 5 is a computer system that performs a “printing” process. As an example, a system including a digital printing apparatus that performs printing without using a printing plate and an offset printing apparatus that performs printing using a printing plate is applied to the printing system 5.

The processing apparatus 6 is an apparatus that performs a “processing” process. As an example, as the processing apparatus 6, a covering apparatus that applies a cover to a part that has been generated as a part of a product, and a collating apparatus that collates a folded part with respect to an offset-printed part are applied.

The printing business of the printed product is not limited to each system and each apparatus described above, and may include other systems and other apparatuses that can be used in the printing business. For example, a draft management system that processes the confirmation of the printed contents, and the confirmation, approval, and request of proceeding to the execution stage of printing by the requester of the printed product, known as draft, may be provided.

FIG. 2 is a block diagram showing an example of an electrical configuration of the information processing apparatus 2 according to the present exemplary embodiment.

As shown in FIG. 2, the information processing apparatus 2 according to the present exemplary embodiment includes a control unit 20, a storage unit 22, a communication unit 24, a display unit 26, and an operation unit 28.

A central processing unit (CPU) 20A, a random access memory (RAM) 20B, a read only memory (ROM) 20C, and an input/output interface (I/O) 20D are included in the control unit 20, and are connected to each other via the bus 20E. Here, the CPU 20A is an example of a processor.

Functional units including the storage unit 22, the communication unit 24, the display unit 26, and the operation unit 28 are connected to the I/O 20D. Each of these functional units can communicate with the CPU 20A via the I/O 20D.

As the storage unit 22, for example, auxiliary storage devices such as a hard disk drive (HDD), a solid state drive (SSD), and a flash memory are used. The storage unit 22 stores an information processing program 22A and various types of data 22B for implementing information processing according to the present exemplary embodiment. The CPU 20A reads the information processing program 22A from the storage unit 22, expands the information processing program 22A into the RAM 20B, and executes processing. Accordingly, the information processing apparatus 2 that has executed the information processing program 22A operates as the information processing apparatus of the present disclosure. The information processing program 22A may be stored in the ROM 20C.

For the display unit 26, for example, a liquid crystal display (LCD), an organic electro luminescence (EL) display, or the like is used. The display unit 26 may integrally have a touch panel. The operation unit 28 is provided with a device for operation input such as a keyboard and a mouse. The display unit 26 and the operation unit 28 receive various instructions from the user of the information processing apparatus 2. The display unit 26 displays various types of information such as a result of a process executed in response to an instruction received from the user and a notification for the process. Further, in the present exemplary embodiment, process candidates and workflows are displayed.

The communication unit 24 is connected to a network N such as the Internet, a LAN, and a WAN, and is capable of communicating with an external device via the network NT.

In the present exemplary embodiment, it is assumed that the information processing apparatus 2 acquires information (hereinafter, referred to as MIS information) necessary for manufacturing a printed product from the MIS 3. This MIS information is, for example, information described in an XML format. As an example, the MIS information includes a part type ID indicating a part configuring a printed product, and various pieces of information on the part. The MIS information may include a workflow template. Further, the information processing apparatus 2 may not acquire the MIS information.

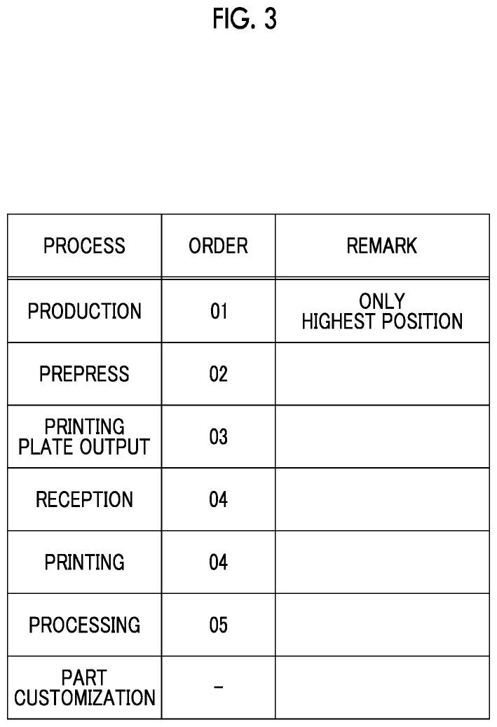

The types and predetermined orders of processes in the present exemplary embodiment will be described with reference to FIG. 3.

In the present exemplary embodiment, as the process, as shown in FIG. 3, there are “production”, “prepress”, “reception”, “printing plate output”, “part customization”, “printing”, “processing”, and the like. “Production” is a process indicating a work of producing a manuscript of a printed product. “Prepress” is used as a general term for the process before printing a printed matter, and generally includes processes such as designing, copying, typesetting, block copy creation, color separation, retouching, weekly sales, and printing plate making, on the submitted manuscripts. In addition, a prepress process may be used to check the quality of the printing result, by performing trial printing as necessary. “Reception” refers to work of receiving a part or a product. “Printing plate output” is a process indicating work of creating a printing plate for printing. “Part customization” is a process of indicating a general term for work of applying a special processing or treatment to a part. “Printing” is a process of performing printing on paper or other printing medium, based on design data for printing. “Processing” is a process of performing processing work to be performed on a printed matter. The processes are not limited to the processes shown in FIG. 3.

The predetermined orders of the processes are the orders shown in FIG. 3. For example, “production” can be added only to the first (top position) of the process for each part in the order configuration list. In addition, “reception” and “printing” have the same order, and are added to the workflow in the order added by the process addition button 112 in the initial state. That is, in a case of adding a process, the process is set such that the arrangement that does not satisfy the order of “production”, “prepress”, “printing plate output”, “reception”, or “printing”, and “processing” is not performed. The user may change the orders of the processes by dragging the processes of the workflow displayed on the workflow display unit 130 with a mouse.

Further, the “part customization” is a process in which the order is not defined, and is added next to the process designated by the user. Specifically, after a process displayed on the order configuration list display unit 120 becomes a designated state by the user clicking the process with the mouse, in a case where “part customization” is selected by operating the process addition button 112, the process is added to the workflow at the next position of the process in the designated state. Note that the “part customization” is not limited to a case where the process is added next to the process designated by the user. For example, the process may be added before the process designated by the user, or the user may select whether to add the process next to or before the process designated by the user. In addition, the “part customization” may be added to the workflow at the last position of the part designated by the user. Specifically, after a part displayed on the order configuration list display unit 120 becomes a designated state by the user clicking the part with the mouse, in a case where “part customization” is selected by operating the process addition button 112, the part may be added to the workflow at the next position of the part in the designated state. Note that the “part customization” is not limited to the case where the part is added to the workflow at the last position of the part designated by the user. For example, the user may select the position to add a part.

In addition, the predetermined order is determined based on the relationship between the selected process and the process that has already been added to the workflow. For example, “printing plate output” has the order of “03”, but in a case where “prepress” having the order of “02” before “printing plate output” is not added to the workflow, “printing plate output” is added in the second position next to “production”. In addition, in a state where “production” and “prepress” are present in the workflow, in a case where “prepress” is added, “prepress” is added in the second position between “production” and “printing plate output” in the workflow. That is, the predetermined order shown in FIG. 3 is not an absolute order but is an order relatively determined in relation to the process added to the workflow.

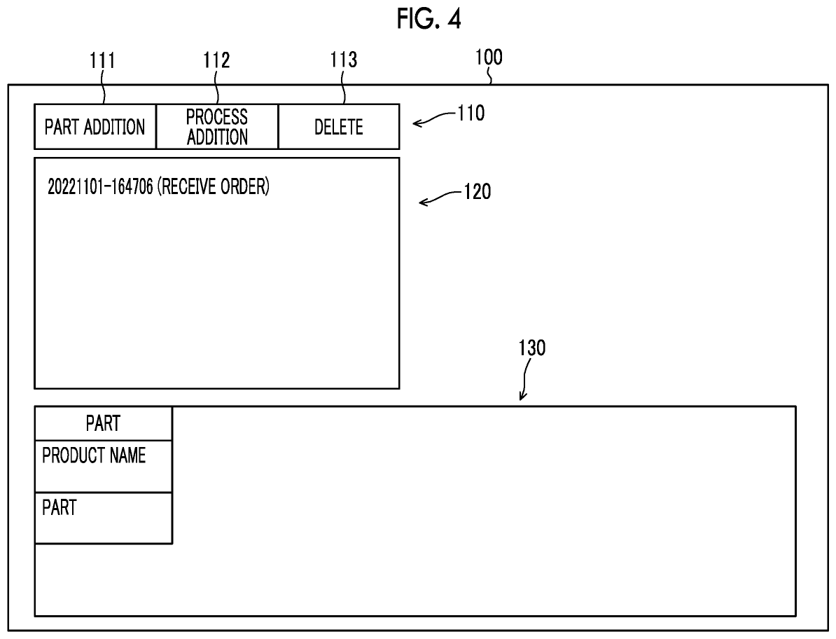

A display example for creating a workflow on the display unit 26 will be described with reference to FIGS. 4 to 9.

FIG. 4 is a diagram showing a display example of the screen 100 on the display unit 26 in a case where the order creation button (not shown) is operated by the user.

The screen 100 includes a button display unit 110, an order configuration list display unit 120, and a workflow display unit 130. In the button display unit 110, a part addition button 111 operated in a case of adding part information, a process addition button 112 operated in a case of adding a process, and a delete button 113 operated in a case of deleting a part or a process are displayed. In addition, the part added by the part addition button 111 and the process added by the process addition button 112 are displayed on the order configuration list display unit 120. In addition, a part added by the part addition button 111 and a workflow including a process added by the process addition button 112 are displayed on the workflow display unit 130.

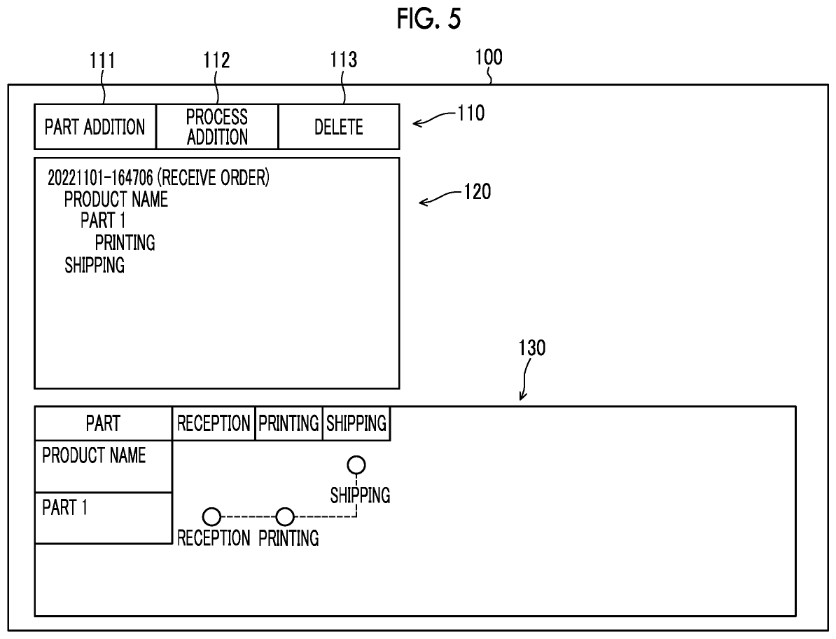

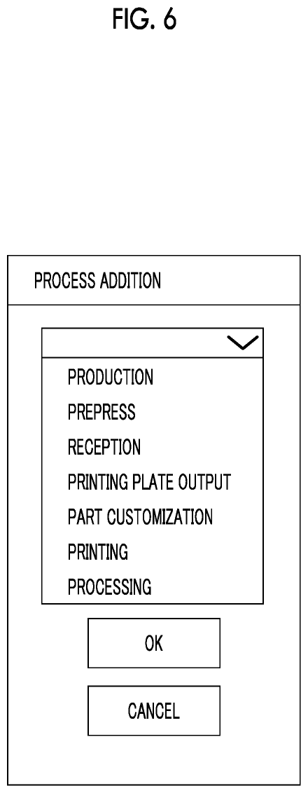

FIG. 5 is a diagram showing a display example of the screen 100 on the display unit 26 in a case where a part and a process of “printing” are added to the part, from the state shown in FIG. 4. Specifically, in the state shown in FIG. 4, the user operates the part addition button 111 to add the “part 1” to the order configuration list display unit 120. Here, the parts configure a printed product, and includes, for example, a “cover page”, a “text”, and a “cover”. Then, in a case where the process addition button 112 is operated on the “part 1” by the user, process candidates are displayed in a list as shown in FIG. 6, and in a case where a process of “printing” is selected from among the displayed processes, the process of “printing” is added to “part 1” on the order configuration list display unit 120 in a predetermined order, and the process of “printing” is added to “part 1” on the workflow display unit 130 in a predetermined order. Further, in the present exemplary embodiment, the processes of “reception” and “shipping” are displayed on the order configuration list display unit 120 and the workflow display unit 130, but this is added by the CPU 20A regardless of the user's operation in a case where some process is added. However, the processes of “reception” and “shipping” may also be added by the user's operation. Here, “reception” is a process indicating a work of receiving a request for manufacturing at least a part of a printed product from a requester, and “shipping” is a process indicating a work of shipping a printed product whose manufacturing is completed.

Further, in the present exemplary embodiment, in the workflow, each process is displayed in order of work, and “◯ (circular figure)” indicating each process is connected by a dotted line and displayed.

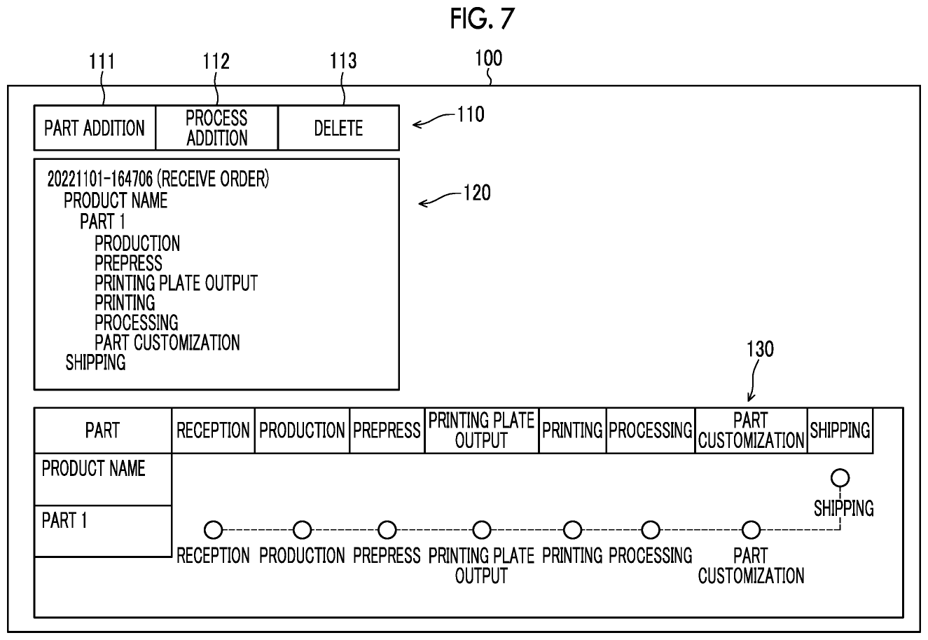

FIG. 7 is a diagram showing a display example of the screen 100 on the display unit 26 in a case where the processes of “production”, “prepress”, “printing plate output”, “processing”, and “part customization” are added by repeating the operation of adding the process by the user, from the state shown in FIG. 5. Here, the order of user's operations of adding the processes of “production”, “prepress”, “printing plate output”, and “processing” does not need to be the order displayed on the workflow display unit 130, as described above, and the processes are rearranged in a predetermined order (see FIG. 3), regardless of the order of operations of adding. That is, for example, even in a case where the process of “printing” is added after the process of “processing” is added, the process of “printing” is added to the workflow before the process of “processing”.

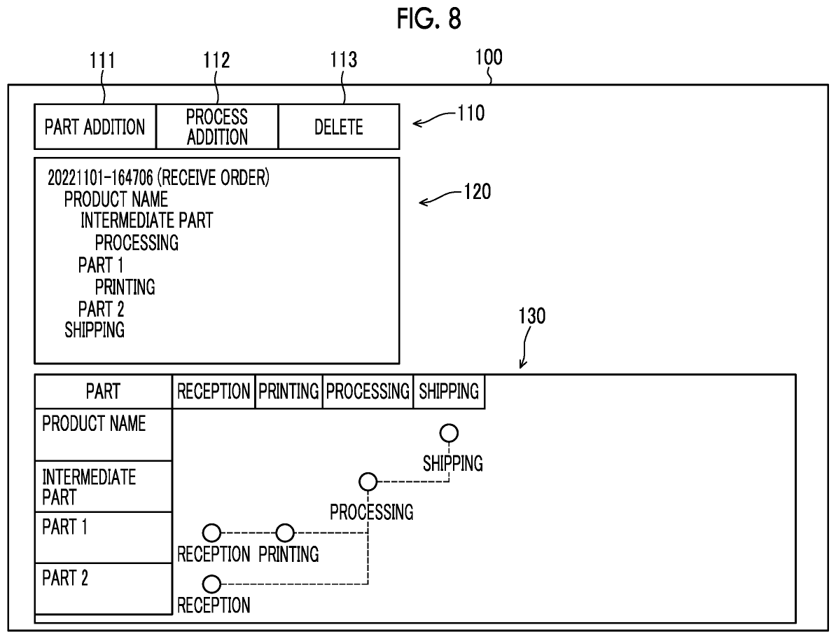

FIG. 8 is a diagram showing a display example of the screen 100 on the display unit 26 in a case where a part is added, from the state shown in FIG. 5. Specifically, in a state shown in FIG. 5, by the user operating the part addition button 111, the “part 2” is added to the order configuration list display unit 120, and the “part 2” is added to the workflow display unit 130. Since the CPU 20A has received a plurality of parts, the CPU 20A adds “intermediate part” which are parts obtained by combining “part 1” and “part 2” to the order configuration list display unit 120 and the workflow display unit 130. Here, in a state where a plurality of parts are included in the workflow, in a case where a process is added, a part, to which the process displayed on the order configuration list display unit 120 is to be added, is designated by the user clicking a mouse, and then by operating the process addition button 112, the process is added to the workflow of the part. In addition, the order of process added to the workflow is the order of each part. That is, the processes are arranged in predetermined orders for “part 1”, the processes are arranged in predetermined orders for “part 2”. Further, the intermediate part includes, for example, a “book block” generated by combining a “front page” and a “text”, a “finished product” generated by combining the “book block” and a “cover”, and the like.

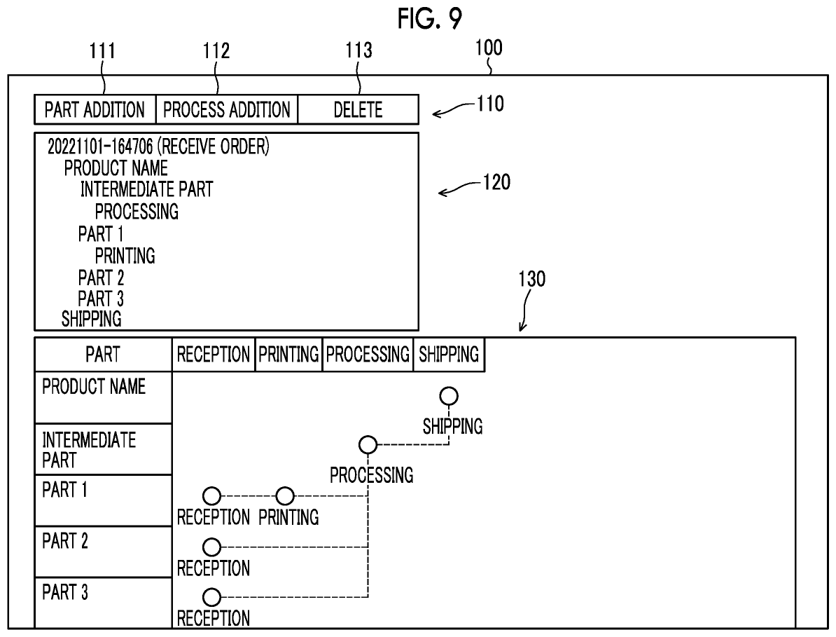

FIG. 9 is a diagram showing a display example of the screen 100 on the display unit 26 in a case where a part is added, from the state shown in FIG. 8. Specifically, in a state shown in FIG. 8, by the user operating the part addition button 111, the “part 3” is added to the order configuration list display unit 120, and the “part 3” is added to the workflow display unit 130. With respect to the “part 3” added to the workflow display unit 130, as shown in FIG. 9, a workflow is created in which the process of the “part 3” is connected to the “intermediate part”.

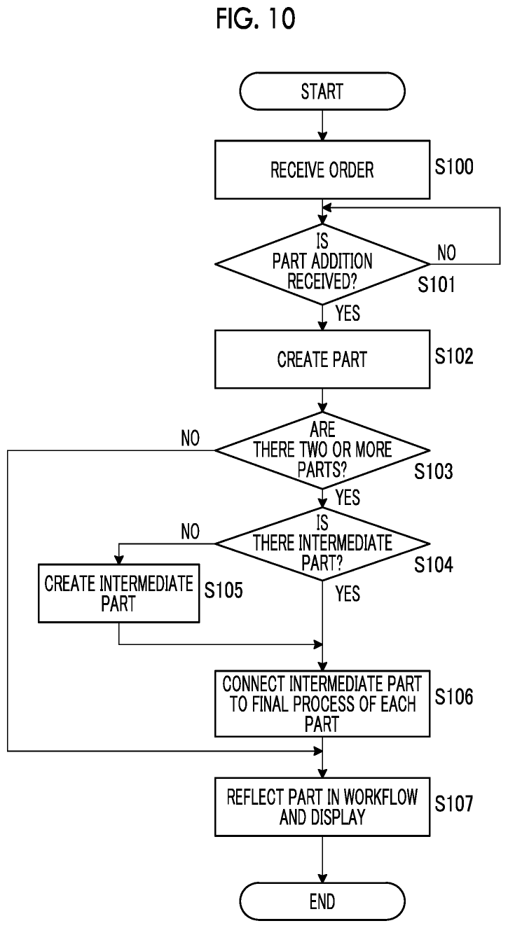

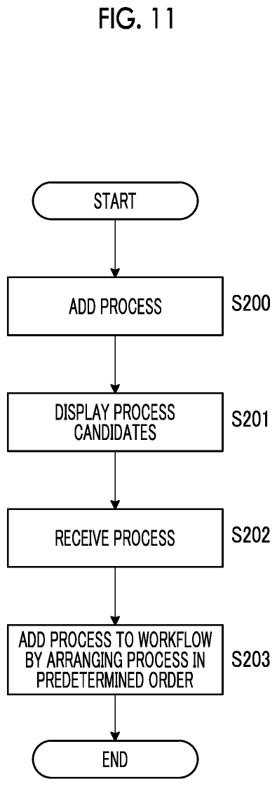

Next, the operation of the information processing apparatus 2 will be described with reference to FIGS. 10 and 11.

FIG. 10 is a flowchart showing an example of a flow of a part creation process of the information processing program 22A executed in the information processing apparatus 2.

In a case where the information processing program 22A is instructed to start in the information processing apparatus 2, the CPU 20A executes each of the following steps. Although not shown, MIS information may be acquired from the MIS 3 as a premise of the present flowchart.

In step S100, the CPU 20A receives an order from the user. Here, the order reception by the user is performed by clicking the order creation button (not shown) displayed on the display unit 26 with a mouse which is an example of the operation unit 28. Then, the process proceeds to the next step S101.

In step S101, the CPU 20A determines whether or not the part addition has been received from the user. In a case where it is determined that the part addition has been received, the process proceeds to the next step S102. In a case where it is not determined that the part addition has been received, the process proceeds to step S101 again. Here, the part addition by the user is performed by clicking the part addition button 111 (see FIG. 4) displayed on the button display unit 110 with a mouse which is an example of the operation unit 28.

In step S102, the CPU 20A creates the part received in step S101 described above. Specifically, names such as “part 1” and “part 2” are given in the order of creation. Then, the parts are displayed on the workflow display unit 130. Here, the name of the part is not limited to the name that the CPU 20A gives, and the user may input the name using the keyboard which is an example of the operation unit 28. Then, the process proceeds to the next step S103.

In step S103, the CPU 20A determines whether or not there are two or more parts, that is, whether or not a plurality of parts including the part created in step S102 are included in the workflow. In a case where it is determined that there are two or more parts, the process proceeds to the next step S104, and in a case where it is not determined that there are two or more parts, the process proceeds to step S107 which will be described later.

In step S104, the CPU 20A determines whether or not there is an intermediate part. That is, it is determined whether or not the intermediate part has already been created and is included in the workflow. In a case where it is determined that there is an intermediate part, the process proceeds to step S106, which will be described later. In a case where it is not determined that there is an intermediate part, the process proceeds to the next step S105.

In step S105, the CPU 20A creates an intermediate part. Then, the created intermediate part is displayed on the workflow display unit 130. Then, the process proceeds to the next step S106.

In step S106, the CPU 20A creates a workflow for connecting the intermediate part created in step S105 described above to the final process of each part. Then, the process proceeds to the next step S107.

In step S107, the part created in step S102 described above and the intermediate part created in step S105 are reflected in the workflow and displayed on the workflow display unit 130. Then, the process ends.

FIG. 11 is a flowchart showing an example of a flow of a process addition process of the information processing program 22A executed in the information processing apparatus 2.

In a case where the information processing program 22A is instructed to start in the information processing apparatus 2, the CPU 20A executes each of the following steps. Although not shown, MIS information may be acquired from the MIS 3 as a premise of the present flowchart.

In step S200, the CPU 20A receives the addition of the process from the user. Here, the process addition by the user is performed by clicking the process addition button 112 (see FIG. 4) displayed on the button display unit 110 with a mouse which is an example of the operation unit 28. Then, the process proceeds to the next step S201.

In step S201, the CPU 20A displays the process candidates on the display unit 26 (see FIG. 6). Then, the process proceeds to the next step S202.

In step S202, the CPU 20A receives the selection of a process from the user. Then, the process proceeds to the next step S203.

In step S203, the CPU 20A adds the processes received in step S200 described above to the workflow by arranging the processes in a predetermined order. Then, the process ends. Here, in a case where a plurality of processes are added, such processes are repeated. In addition, the created workflow is stored in the storage unit 22.

### Modification Example

The present invention is not limited to the above-described exemplary embodiment, and various modifications and applications are possible without departing from the gist of the present invention.

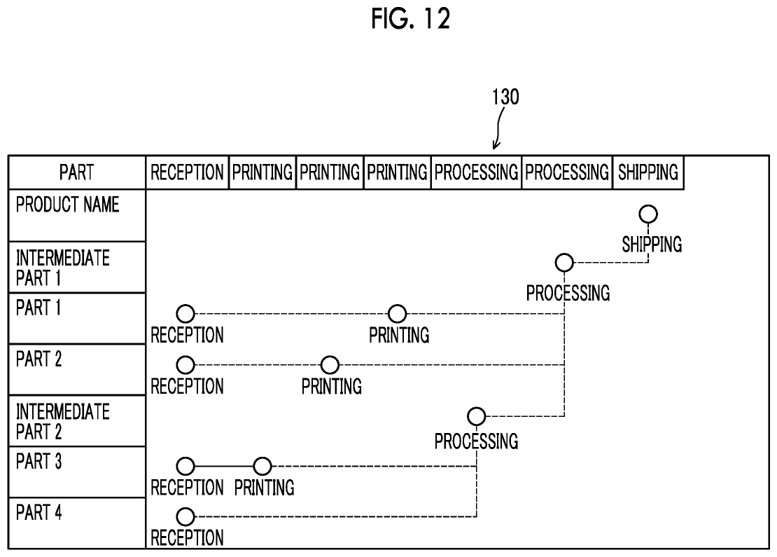

The present invention is not limited to creating a workflow in which all parts are connected to one intermediate part. For example, as shown in FIG. 12, a workflow in which a part 1 and a part 2 are connected to an intermediate part 1, and a part 3 and a part 4 are connected to an intermediate part 2 may be created. In this case, in a case where a part is designated by the user and information on another part is received, an intermediate part created from the part designated by the user and the other part on which the information is received is added to a workflow. Further, in a case where the intermediate part is designated by the user and then the part is received, the part may be added to the workflow connected to the designated intermediate part. In addition, the user may be able to select a part connected to the intermediate part.

Further, the addition of the part is not limited to the case where the addition of the part is performed by operating the part addition button 111, and the part may be acquired from the MIS information.

Further, the processes need not to be added one by one, and a plurality of processes may be added at the same time. Specifically, a plurality of processes may be selected from among the processes displayed in a list, and after the selection, a plurality of processes may be added to the workflow at the same time by operating an OK button or the like.

In the above exemplary embodiment, the aspect in which the program is stored (installed) in the storage unit 22 in advance has been described, but the present invention is not limited thereto. The program may be provided in a form recorded on a recording medium such as a compact disk read only memory (CD-ROM), a digital versatile disk read only memory (DVD-ROM), and a universal serial bus (USB) memory. Further, the program may be downloaded from an external device via the network NT.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The following will be further disclosed with respect to the above exemplary embodiment.

(((1)))

An information processing apparatus comprising:
a processor configured to:
   receive information on a plurality of parts that configure a product;
   display process candidates for manufacturing the parts on a display unit;
   receive selection of a process from among the process candidates, for each of the parts; and
   create a workflow related to manufacturing of the product, including the selected process.

(((2)))

The information processing apparatus according to (((1))), wherein the processor is configured to:
add the received process to the workflow, every time the selection of the process is received.

(((3)))

The information processing apparatus according to (((1))) or (((2))), wherein the processor is configured to:
arrange the process selected for each part in a predetermined order and add the process to the workflow.

(((4)))

The information processing apparatus according to (((3))),
wherein the predetermined order is determined based on a relationship between the selected process and a process that has already been added to the workflow.

(((5)))

The information processing apparatus according to (((2))) or (((3))),
wherein in a case where the process displayed on the display unit is designated by a user and selection of another process is received, the selected process is added to a workflow at a position next to the designated process.

(((6)))

The information processing apparatus according to (((2))) or (((3))),
wherein in a case where a part displayed on the display unit is designated by a user and selection of the process is received, the selected process is added to a workflow at a last position of the part.

(((7)))

The information processing apparatus according to any one of (((1))) to (((6))), wherein the processor is configured to:
in a case where the information on the plurality of parts is received, add an intermediate part obtained by combining the plurality of parts to the workflow.

(((8)))

The information processing apparatus according to (((7))), wherein the processor is configured to:
with respect to a part on which information is received after generation of a workflow including the intermediate part, create a workflow in which the process of the part is connected to the intermediate part.

(((9)))

The information processing apparatus according to any one of (((1))) to (((8))), wherein the processor is configured to:
in a case where a part is designated by a user and information on another part is received, add an intermediate part created from the part designated by the user and the other part on which the information is received to a workflow.

(((10)))

A non-transitory computer readable medium storing a program causing a computer to execute a process comprising:
receiving information on a plurality of parts that configure a product;
displaying process candidates for manufacturing the parts on a display unit;
receiving selection of a process from among the process candidates, for each of the parts; and
creating a workflow related to manufacturing of the product, including the selected process.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
receive information on a plurality of parts that configure a product;
display process candidates for manufacturing the parts on a display unit;
receive selection of a process from among the process candidates, for each of the parts; and
create a workflow related to manufacturing of the product, including the selected process.

2. The information processing apparatus according to claim 1, wherein the processor is configured to:
add the received process to the workflow, every time the selection of the process is received.

3. The information processing apparatus according to claim 1, wherein the processor is configured to:
arrange the process selected for each part in a predetermined order and add the process to the workflow.

4. The information processing apparatus according to claim 3,
wherein the predetermined order is determined based on a relationship between the selected process and a process that has already been added to the workflow.

5. The information processing apparatus according to claim 2,
wherein in a case where the process displayed on the display unit is designated by a user and selection of another process is received, the selected process is added to a workflow at a position next to the designated process.

6. The information processing apparatus according to claim 3,
wherein in a case where the process displayed on the display unit is designated by a user and selection of another process is received, the selected process is added to a workflow at a position next to the designated process.

7. The information processing apparatus according to claim 2,
wherein in a case where a part displayed on the display unit is designated by a user and selection of the process is received, the selected process is added to a workflow at a last position of the part.

8. The information processing apparatus according to claim 3,
wherein in a case where a part displayed on the display unit is designated by a user and selection of the process is received, the selected process is added to a workflow at a last position of the part.

9. The information processing apparatus according to claim 1, wherein the processor is configured to:
in a case where the information on the plurality of parts is received, add an intermediate part obtained by combining the plurality of parts to the workflow.

10. The information processing apparatus according to claim 9, wherein the processor is configured to:
with respect to a part on which information is received after generation of a workflow including the intermediate part, create a workflow in which the process of the part is connected to the intermediate part.

11. The information processing apparatus according to claim 1, wherein the processor is configured to:
in a case where a part is designated by a user and information on another part is received, add an intermediate part created from the part designated by the user and the other part on which the information is received to a workflow.

12. A non-transitory computer readable medium storing a program causing a computer to execute a process comprising:
receiving information on a plurality of parts that configure a product;
displaying process candidates for manufacturing the parts on a display unit;
receiving selection of a process from among the process candidates, for each of the parts; and
creating a workflow related to manufacturing of the product, including the selected process.

13. An information processing apparatus comprising:
means for receiving information on a plurality of parts that configure a product;
means for displaying process candidates for manufacturing the parts on a display unit;
means for receiving selection of a process from among the process candidates, for each of the parts; and
means for creating a workflow related to manufacturing of the product, including the selected process.
